(19) United States
(12) Patent Application Publication
(10) Pub. No.: US 2012/0166363 A1
(43) Pub. Date: Jun. 28, 2012

(54) NEURAL NETWORK FAULT DETECTION SYSTEM AND ASSOCIATED METHODS

(76) Inventors: Hongbo He, Alberquerque, NM (US); Andrea Mammoli, Corrales, NM (US); Thomas Caudell, Edgewood, NM (US)

(21) Appl. No.: 13/333,511

(22) Filed: Dec. 21, 2011

Related U.S. Application Data
(60) Provisional application No. 61/460,039, filed on Dec. 23, 2010.

(51) Int. Cl. G06N 7/04; G06F 17/00; G06N 3/02

(52) U.S. Cl. 706/2; 706/20; 706/11

(57) ABSTRACT

A fault detection system for use with a solar hot water system may include a data acquisition module which may, in turn, include a plurality of sensors. Input data may include a sensed condition. The system may also include a neural network to receive the input data which may be a multi-layer hierarchical adaptive resonance theory (ART) neural network. The neural network may perform an analysis on the input data to determine existence of a fault or a condition indicative of a potential fault. The fault and the condition indicative of the potential fault are prioritized according to the analysis performed by the neural network. A warning output relating to the fault and the condition indicative of the potential fault is generated responsive to the analysis, and is displayed on the user interface.

### RELATED APPLICATIONS

This application claims priority from U.S. Provisional Patent Application Ser. No. 61/460,039 filed on Dec. 23, 2010 by the inventors of the present application and titled REAL-TIME FAULT DETECTION SYSTEM AND METHODS, the entire contents of which are incorporated herein by reference.

### FIELD OF THE INVENTION

The present invention relates to the field of solar hot water systems and, more specifically, to fault prediction systems for solar hot water systems.

### BACKGROUND OF THE INVENTION

Solar hot water (SHW) systems are generally expected to last for 20 years with little or no maintenance. However, in many cases, failures occur far sooner due to a variety of problems, many of which are undetected or detected long after the system has failed. Some failures may cause the SHW system to run inefficiently, or, in some cases, damage other system components. Of most concern is the fact that these failures cause the system to stop converting renewable energy, creating a draw of energy from the grid or other producers. This is disadvantageous to the environment, the owner of the SHW system, and any entity, such as a government, that may provide incentives related to SHW systems.

In many failure scenarios, the fault goes unnoticed by the SHW system owner because the backup energy source, typically a gas-fired or electric backup system, produces energy to heat the water. Unless the owner diligently monitors the SHW system's operation, the fault may go unnoticed for weeks, or, in some cases, years. Prompt notification of the fault would greatly benefit the value of a SHW system by minimizing its down time and decreasing the chance of complete system failure.

Generally, the reliability of any system can be improved by knowing its end-of-life characteristics—that is, its mean life along with a standard deviation around that mean. If such data exist, failures of components can be predicted with some fixed probability, and the user can then choose to replace components preemptively, before a failed component creates a system failure. Unfortunately, these statistics are unknown for SHW systems. As a result, SHW systems fail at a relatively high rate. A recent study conducted by David Menicucci for Sandia National Labs found that, in some cases, at least 50% of SHW systems were not operating after 10 years in the field. Collection of end-of-life data, however, is a very expensive and long-term endeavor. Even if end-of-life data collection efforts were started today, many years would be needed to collect enough data to make essential predictions that could improve SHW reliability.

In the absence of end-of-life statistical data, different techniques may be employed to predict failures of components. For example, U.S. Pat. No. 4,626,832 to Farrington et al. describes using eleven sensors to detect four kinds of faults. Unfortunately, some of the sensors of the Farrington et al. '832 system are expensive, such as the flow rate sensor. The low cost of SHW systems does not warrant the installation of such apparatus, especially for residential units. There exists a need for a fault detection system which uses a limited set of commonly available measured data with advanced detection and prediction capabilities.

### SUMMARY OF THE INVENTION

When properly trained, neural network based technology of the present invention has the capability to identify components in SHW systems that might fail based on performance anomalies, which are typically present in the system some time prior to failure. The adaptive resonance theory (ART) technology implemented in the present invention consists of detection algorithms that can be easily integrated into existing SHW system controllers, most of which are microprocessor based. With the addition of these algorithms operating in the controller, SHW system controllers may be more capable to announce a failure of a component or to predict an impending occurrence of a component failure. Furthermore, since ART technology is software based, it may be updated over time. It may be possible to regularly upload improved algorithms to existing controllers if they are connected to the internet, as many are now.

The use of ART technology in SHW systems holds potential to solve a long-felt need in the art of SHW systems: reliability. Use of this new technology in SHW systems will help keep the systems operating for their full life expectancy, thus maximizing the benefit of reduced fossil energy consumption to the world.

These and other goals, features and objectives, according to an embodiment of the present invention, are provided by a fault detection system for use with a solar hot water system. The fault detection system may include a data acquisition module to collect input data relating to the solar hot water system. The data acquisition module may include a plurality of sensors in communication with portions of the solar hot water system. The input data may be related to a sensed condition sensed by one of the sensors. The system also includes a neural network in communication with the data acquisition module to receive the input data. The neural network is preferably a multi-layer hierarchical adaptive resonance theory (ART) neural network.

The system may also include a user interface in communication with the neural network, the data acquisition module, or both. The data acquisition module may transmit the input data to the neural network, and the neural network may perform an analysis on the input data to determine existence of a fault or a condition indicative of a potential fault. The fault and the condition indicative of the potential fault may be prioritized according to the analysis performed by the neural network. A warning output relating to the fault or the condition indicative of the potential fault may be generated responsive to the analysis, and may be displayed on the user interface.

The plurality of sensors may be provided by a collector outlet temperature sensor, a storage water tank top temperature sensor, a controller signal sensor, a collector inlet temperature sensor, a collector fin temperature sensor, a storage water tank bottom temperature sensor, a flow rate sensor, an ambient temperature sensor, a global radiation sensor, a beam radiation sensor, an incidence angle sensor, a wind speed sensor, a relative humidity sensor, or a time of day sensor.

The fault and the condition indicative of the potential fault may be related a collector fault indicating a fault or potential fault with a solar collector of the solar hot water system, a pipe fault indicating a fault or potential fault in a pipe of the solar hot water system, a pump fault indicating a fault or potential fault with a pump of the solar hot water system, a thermosiphon fault indicating a fault or potential fault with a thermosiphon of the solar hot water system, a scaling fault indicating that scales have built up on a portion of the solar hot water system, a shading fault indicating that a portion of the solar hot water system is in shade, or an unknown fault indicating another type of fault or potential fault.

The neural network may comprise a plurality of cascading layers of Fuzzy ART networks. Each of the cascading layers of Fuzzy ART networks may be calibrated to have a vigilance level substantially proportional to its numerical layer value. The vigilance level may be defined by a threshold similarity between patterns of the input data and patterns known to the neural network. The analysis may include passing the input data to incrementally higher numerical cascading layers of Fuzzy ART networks in the neural network until the fault or the condition indicative of the potential fault are found. The analysis may also include assigning the fault or the condition indicative of the potential fault a priority based on the numerical cascading layers in which the fault and the condition indicative of the potential fault are found. The neural network may identify the fault and the condition indicative of the potential fault as a fault type based on the input data received by the neural network and based on the priority assigned to the fault and the condition indicative of the potential fault during the analysis of the input data.

The solar hot water system may include a controller that controls operation of the solar hot water system. The neural network may be in communication with the controller. The controller may receive an output control signal relating to operation of the solar hot water system from the neural network. Accordingly, the controller may transmit a control signal to the solar hot water system. The control signal may be generated responsive to the analysis and the warning output.

The warning output may include a prompt that allows the user to make a choice using the user interface. The choice may be any one or more of shutting down the solar hot water system, viewing more information relating to the warning output, waiting a time period and reviewing a new warning output at a later time, or ignoring the warning output. The user may be a solar hot water system monitoring service or a maintenance service, and the user interface may be positioned at a facility associated with the solar hot water system monitoring service or the maintenance service. The neural network may be a learning system that includes a knowledge base. The knowledge base of the neural network may be augmented based on the choice of ignoring the warning output signal being selected,

A method aspect of the present invention is for using a fault detection system with a solar hot water system. The method may include collecting the input data relating to the solar hot water system, transmitting the input data from the data acquisition module to the neural network, and executing a command to perform an analysis on the input data within the neural network. The method may also include determining the existence of a fault or a condition indicative of a potential fault, and prioritizing the fault and/or the condition indicative of the potential fault according to the analysis performed by the neural network. The method may still further include generating a warning output relating to the fault or the condition indicative of the potential fault responsive to the analysis, and displaying the warning output on the user interlace. The method may also provide a prompt that allows a user to make a choice using the user interface. The choice may include any one or more of shutting down the solar hot water system, viewing more information relating to the warning output, waiting a time period and reviewing a new warning output at a later time, or ignoring the warning output. The method may also include transmitting an output control signal relating to operation of the solar hot water system from the neural network to the controller.

### BRIEF DESCRIPTION OF THE DRAWINGS

FIG. 1 is a schematic diagram of the fault detection system according to an embodiment of the present invention in use in a model SHW system,

FIG. 2 is a schematic diagram of a model computer for use in connection with the fault detection system according to an embodiment of the present invention.

FIG. 3 is a schematic diagram of a warning output on a user interface of the fault detection system according to an embodiment of the present invention.

FIG. 4 is a schematic diagram of Fuzzy ART architecture as implemented in the fault detection system according to an embodiment of the present invention.

FIG. 5 is a flowchart demonstrating a method of operating a fault detection system using Fuzzy ART architecture according to an embodiment of the present invention.

FIG. 6 is a schematic diagram of a hierarchical ART architecture as implemented in the fault detection system according to an embodiment of the present invention.

FIGS. 7-11 are flowcharts illustrating methods of operating a fault detection system according to embodiments of the present invention.

FIG. 12 is a graphical illustration of how a hierarchical ART neural network of the fault detection system according to an embodiment of the present invention learns.

FIG. 13 is a graphical illustration of temperature data collected by a sensor for use by the fault detection system according to an embodiment of the present invention.

FIG. 14 is a three-dimensional graphical illustration of results of analysis and categorization of the temperature data collected in FIG. 13 by the neural network of the fault detection system according to an embodiment of the present invention.

FIG. 15 is a flowchart illustrating a method of operating a fault detection system according to an embodiment of the present invention,

FIG. 16 is a schematic diagram of information flow in a multilayer hierarchical Fuzzy ART neural network of a fault detection system according to an embodiment of the present invention.

FIG. 17 is a schematic diagram showing hierarchy of SHW system data sets generalized by a four layer hierarchical ART neural network of a fault detection system according to an embodiment of the present invention,

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Embodiments of the present invention are described herein using the context of a system for accurately sensing and predicting faults and failures within a solar hot water system. Those of ordinary skill in the art will realize that the following embodiments of the present invention are only illustrative and are not intended to be limiting in any way. Other embodiments of the present invention will readily suggest themselves to such skilled persons having the benefit of this disclosure.

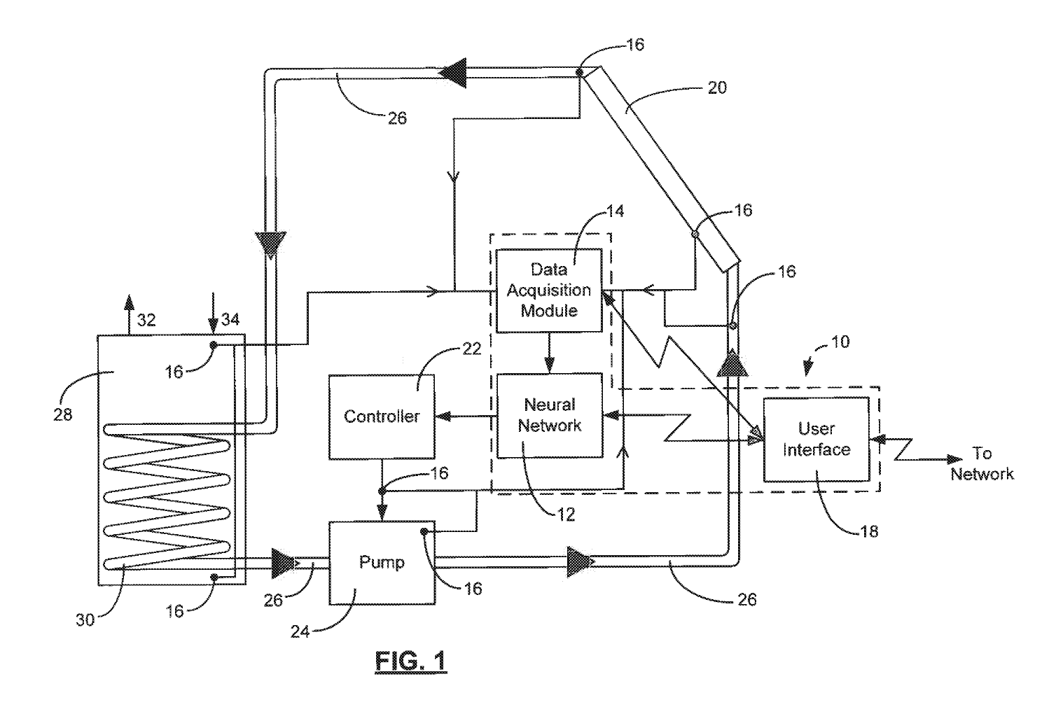

Referring now to FIG. 1, a fault detection system 10 of the present invention will now be discussed in greater detail. FIG. 1 depicts the use of a neural network 12 and a data acquisition module 14 in an exemplary solar hot water (SHW) system 8. The data acquisition module 14 may have a plurality of sensors 16 placed throughout the SHW system 8 to sense various conditions therein. The plurality of sensors 16 may collect a variety of input data that may relate to a sensed condition within the SHIN system 8. Accordingly, the data acquisition module 14 may collect the input data using the plurality of sensors 16 that are in communication with various portions of the SHW system 8. A skilled artisan will recognize that the plurality of sensors 16 may include, but are not intended to be limited to, a collector outlet temperature sensor, a storage water tank top temperature sensor, a controller signal sensor, a collector inlet temperature sensor, a collector fin temperature sensor, a storage water tank bottom temperature sensor, a flow rate sensor, an ambient temperature sensor, a global radiation sensor, a beam radiation sensor, an incidence angle sensor, a wind speed sensor, a relative humidity sensor, and a time of day sensor,

The fault detection system 10 according to an embodiment of the present invention may include a user interface 18. The user interface 18 may, for example, be provided by a computerized device, as will be discussed in greater detail below. The skilled artisan will appreciate, however, after having had the benefit of reading this disclosure, that any type of device suitable for performing calculations, processing information and storing data may be used to accomplish the goals, features and objectives according to an embodiment of the present invention. The user interface 18 is positioned in communication with the data acquisition module 14 and/or the neural network 12. Those skilled in the art will appreciate that there exists any number of ways by which the user interface 18 may be positioned in communication with the data acquisition module 14 and the neural network 12 including all known and contemplated wireless systems, network systems and hard wired systems.

The data acquisition module may transmit the input data to the neural network. More specifically, once the input data is collected by the data acquisition module 14 using the sensors 16 of the SHW system 8, the input data may be transmitted to the neural network 12 for analysis. The neural network 12 may perform an analysis on the input data to determine the existence of either a fault or a condition indicative of a potential fault. A fault may, for example, be considered a detection of any portion of the SHW system 8 that may be malfunctioning. For example, a fault may be detected if a sensor 16 within the SHW system 8 senses a condition indicative of a leak in one of the pipes of the SHW system. This sensed condition may, for example, be a decrease in water flow, a decrease in pressure, or even a moisture sensor positioned external to the pipe. Those skilled in the art will appreciate that there exist several different types of sensors suitable for sensing several different types of conditions within the SHW system 8 and from which various faults can be detected. A condition that may be indicative of a fault is meant to include those conditions that provide an indication that a fault may occur in the near future, but that has not occurred yet. Such a sensed condition, i.e., a sensed condition that is indicative of a fault, may also be used to provide an indication that maintenance may be necessary for a portion of the SHW system 8. Such maintenance may be routine scheduled maintenance, or maintenance that is determined is necessary to prevent a malfunction from occurring.

As will be discussed in greater detail below, the neural network 12 may perform an analysis, or a series of analyses, on the input data that is gathered using the sensors 16 throughout the SHW system 8. The analysis is used to determine the existence of either the fault (discussed in detail above) or the condition indicative of the fault (also discussed in greater detail above). Upon determining that either a fault or a condition indicative of a fault exists, a prioritization process may take place. More particularly, either or both of the fault and the condition indicative of the fault may be prioritized according to the analysis performed by the neural network 12. Prioritization of the fault and the condition indicative of the fault is discussed in greater detail below.

Once the input data has been analyzed, the neural network 12 may generate a warning output 36 relating to either the fault that was detected using the sensors 16, or the condition indicative of the fault. The warning output 36 may be generated responsive to the analysis that is performed by the neural network 12. In other words, as the neural network 12 analyzes the input data, the results of the analysis of the input data may be used to trigger generation of the warning output 36. The warning output may be transmitted to a user interface 18 for display thereon.

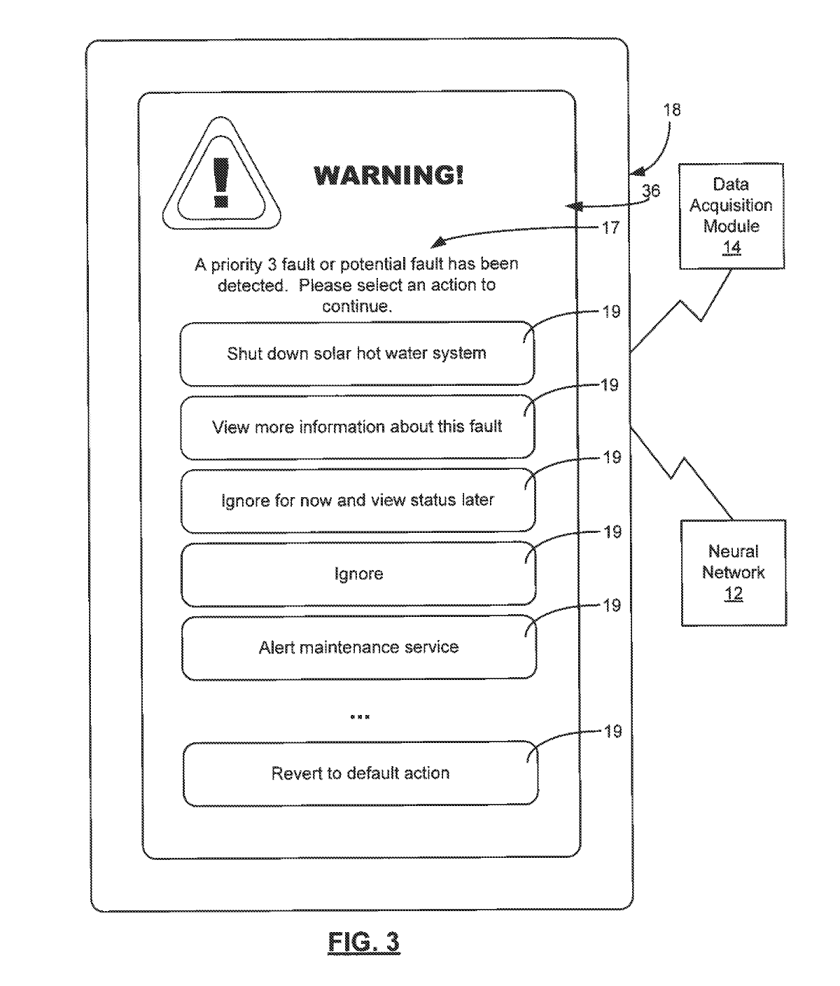

Alternatively, the data acquisition module 14 may communicate data to the user interface 18, including the warning output 36. The warning output 36 is also illustrated in FIG. 3, and will be discussed in greater detail below. As indicated above, the user interface 18 may be in communication with the neural network 12 and/or the data acquisition module 14. The skilled artisan will recognize that the means of communication between the user interface 18 and the neural network 12 and/or data acquisition module 14 may be via metallic cable, fiber optic cable, a network, a radio, a cellular network, or any other type of communication suitable for transmitting information between the neural network 12, the data acquisition module 14 and the user interface 18.

Continuing to refer to FIG. 1, additional features of the system 10 according to an embodiment of the present invention are now provided. The neural network 12 may send an output control signal to a controller 22 of the SHW system 8, and the pump controller may, in turn, send a control signal to the SHW system. The output control signal may relate to operation of the pump 24 of the SHW system 8. More specifically, the output control signal may include information or commands relating to operating the pump 24 in an on position, and an off position, or relating to intensity of operation of the pump. Those skilled in the art will appreciate, however, that the control signal is meant to incorporate any operation control relating to the SHW system 8. The controller 22 of the SHW system 8 is used to control operation of the SHW system. Accordingly, the controller 22 is in communication with the neural network 12 of the fault detection system 10 so that the controller may exchange data and other signals with the neural network. The skilled artisan will recognize that the control signal may be generated responsive to the analysis performed by the neural network 12, as well as the warning output 36, according to an embodiment of the present invention. The pump 24 of the SHW system 8 may be used to pump a thermal transfer fluid through pipes 26 of the SHW system. A skilled artisan may recognize that the thermal transfer fluid may be water, a water/glycol mix, or any other fluid known to be useful for heat transfer. The thermal transfer fluid may travel through pipes 26 in a manner so that solar energy may be transferred from a solar collector 20 (or a plurality of solar collectors in some embodiments) to the thermal transfer fluid being carried through the pipes, to thereby transfer heat to water to be heated.

Those skilled in the art will appreciate that the system 10 according to an embodiment of the present invention is suitable for use with any number of SHW systems, and many different variations of SHW systems. In the embodiment illustrated in FIG. 1, the thermal transfer fluid may flow through a heat exchanger 30, which may be contained in a storage water tank 28. The storage water tank may include a cold water inlet 34 and a hot water outlet 32 to circulate heated water to a desired location. The skilled artisan will recognize that the fault detection system 10 of an embodiment of the present invention may be used in any SHW system, and is not intended to be limited to the specific SHW system shown. As indicated above, there exist several variations of SHW systems, and the fault detection system 10 according to an embodiment of the present invention is suitable for use with any variation of a SHW system.

The skilled artisan will appreciate that the system 10 according to an embodiment of the present invention contemplates that the neural network 12 may send an output control signal to a pump controller as well as the controller 22. More specifically, it is contemplated that one embodiment of the system 10 may be directed to controlling the pump 24 of the SHW system 8 so that the action taken in response to detection of a fault or a condition indicative of a fault is moving the pump of the SHW system 8 between an on position and an off position.

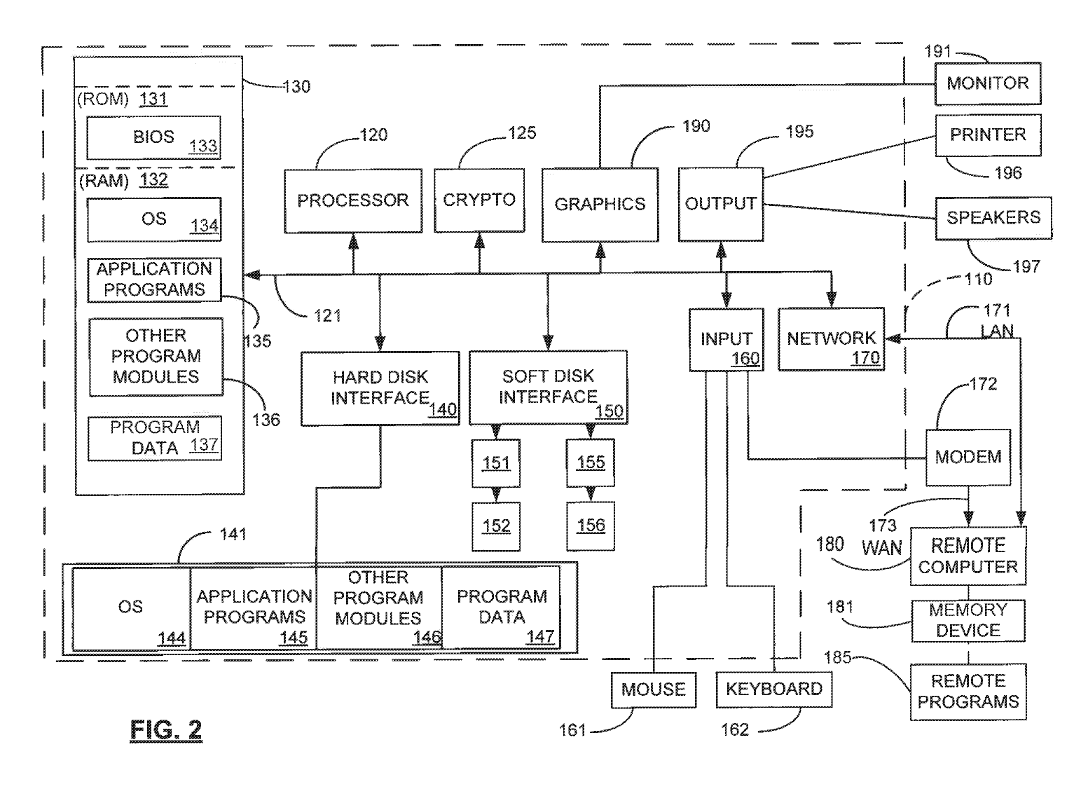

A skilled artisan will note that one or more of the aspects of the present invention may be performed on a computing device. More specifically, the fault detection system 10 according to an embodiment of the present invention is tied to a machine or apparatus such as a computing device. The skilled artisan will also note that a computing device may be understood to be any device having a processor, memory unit, input, and output. This may include, but is not intended to be limited to, cellular phones, smart phones, tablet computers, laptop desktop computers, personal digital assistants, etc. FIG. 2 illustrates a model computing device in the form of a computer 110, which is capable of performing one or more computer-implemented steps in practicing the method aspects of the present invention. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In other embodiments, the functions of the cryptographic unit may be instantiated in software and run via the operating system.

A computer 110 typically includes a variety of computer readable media. Computer readable media can be any available media that can be accessed by a computer 110 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates an operating system (OS) 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives, and their associated computer storage media discussed above and illustrated in FIG. 2, provide storage of computer readable instructions, data structures, program modules and other data for the computer 110. In FIG. 2, for example, hard disk drive 141 is illustrated as storing an OS 144, application programs 145, other program modules 146, and program data 147. Note that these components can either be the same as or different from OS 134, application programs 135, other program modules 136, and program data 137. The OS 144, application programs 145, other program modules 146, and program data 147 are given different numbers here to illustrate that, at a minimum, they may be different copies. A user may enter commands and information into the computer 110 through input devices such as a keyboard 162 and cursor control device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 and 172 allow the device to communicate with other devices. The communications connections 170 and 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

The computing device of FIG. 2 may be used to process commands to perform operations relating to the SHW system 8. Such a device may be used for any of the user interface 18, neural network 12, pump controller 22, or data acquisition module 14. A skilled artisan will note that, while any and all of these devices may be computer-based, each individual device need not necessarily be computer based. Further, the aforementioned devices may be in communication with each other by any method in the electronic arts known to be useful in facilitating electronic communication, such as a metallic wire, an optic cable, a wireless connection, a network, etc. Further, the skilled artisan will appreciate that any or all of the aforementioned devices may be included together as a single unit within a computing system, such as on a server or any type of personal computer. These are not comprehensive lists, and many additional embodiments suitable for carrying out the goals, features, and objectives of the present invention, which are meant to be included herein.

Referring now to FIG. 3, a model user interface 18 will be discussed in greater detail. The model user interface 18 may receive and display a warning output 36 from a neural network 12 or data acquisition module 14. The warning output 36 may include information 17 relating to a fault or potential fault within the SHW system 8, and may provide options 19 for a user to make regarding operation of the SHW system with respect to the fault or potential fault. The options may include, but are not intended to be limited to, shutting down the SHW system 8, viewing more information relating to the warning output 36, waiting a time period and reviewing a new warning output 36 at a later time, ignoring the warning output 36, or any other option of the user or manufacturers choice, such as allowing a control system to make the choice, running the pump 24 of the SHW system, or contacting a SHW system maintenance professional or maintenance service. Should a user wish to view more information relating to the warning output 36, the user may use the user interface 18 to request additional information. For example, the information may include historical data, current data, fault type, and suspected fault cause, among other data, such as last date of maintenance for the component associated with the fault or potential fault, the age of the component associated with the fault or the potential fault, or other routine information related to the component associated with the fault or the potential fault, as would be recognized by a skilled artisan.

The neural network 12 may include a knowledge base. The knowledge base may, for example, be provided by a memory, cloud or other database adapted to store information and data directed to operation of the SHW system 8. Further, the neural network 12 of the fault detection system 10 according to an embodiment of the present invention may be a learning system. Those skilled in the art will appreciate that each node 50 in the neural network 12 is capable of machine learning in order to enhance the knowledge base from which various decisions may be made and indications provided. Accordingly, it is also contemplated that each node 50 of the neural network 12 may be provided, for example, by an intelligent machine, or any other system capable of machine learning or having artificial intelligence. The system 10 according to an embodiment of the present invention contemplates that selecting the option 19 of ignoring the warning output 36 may augment the knowledge base of the neural network 12. Selecting an “ignore” command may, for example, send a signal to the neural network 12 that the condition that is sensed and analyzed may not, in fact, be a fault. This may prevent more false warning outputs in the future, as may be appreciated by one having skill in the art. The skilled artisan will also appreciate that, alternately, a feedback screen may be presented on the user interface after selecting any option 19 presented in the warning output 36. The feedback screen may request data from the user, including reasons for selecting a specific option 19, the actual cause of the detected fault or potential fault, and any additional action that may have been taken by the user. It is further contemplated that the warning output may provide the user with an option to override any indication of a fault or a potential fault. If an override option is selected, the system may display a prompt on the user interface 18 requesting additional information or support for reasons of overriding such an indication. Further, it is contemplated that selection of an override may require compliance with a rule or set of rules that may be stored on a database and/or the knowledge base of the neural network.

The user interface 18 may be used in the following systems including, but not limited to, a standalone system, as a hardwired component of the SHW system, a personal computer such as a laptop, desktop, tablet computer, or netbook, a mobile phone using an automated voice or SIMS system, or on a smart phone such as an iPhone, a Blackberry, an Android, or Windows Phone. Other suitable devices may readily come to mind of one skilled in the art having the benefit of this disclosure while still accomplishing the goals, features, and objectives of the present invention, and are intended to be included herein. The skilled artisan will recognize that the user interface 18 according to an embodiment of the present invention may be positioned at any location due to the variety of systems in which the user interface may be used. Such flexibility may allow the user interface 18 to be located, for example, at a facility associated with maintenance of the SHW system 8.

The fault detection system 10 according to an embodiment of the present invention also contemplates that the user may be any user, and it not limited to an individual. For example, the user may be provided by a SHW system monitoring service or a maintenance service. The user may also be provided by any other alternative operator of the fault detection system 10. This is meant to account for the possibility that the SHW system 8 may be operated remotely, may be maintained by a separate service, or may be maintained by an entity separate from the user.

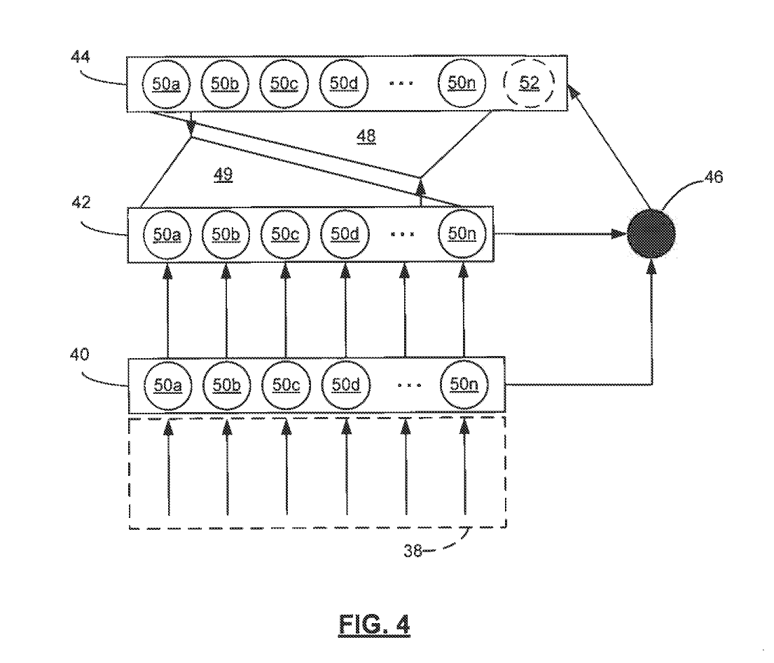

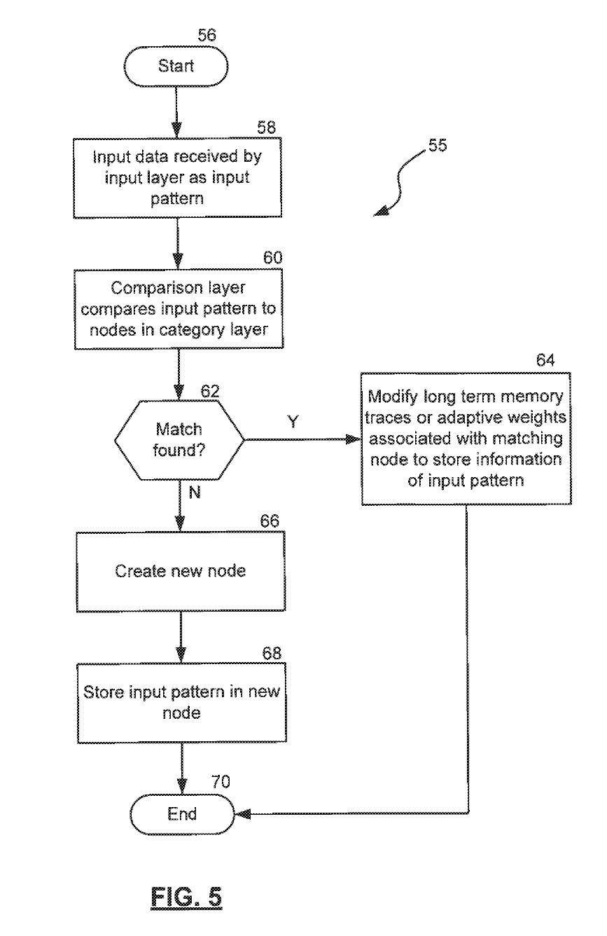

Referring now to FIGS. 4 and 5, the neural network 12 will now be discussed in greater detail. FIG. 4 depicts a schematic diagram of the architecture of a Fuzzy ART neural network 12. Those skilled in the art will appreciate that Fuzzy ART neural networks are ART neural networks adapted to accept analog inputs as well as binary inputs. The adaptations to the analytical processes of the ART neural networks to accept analog inputs are simple, and are discussed at greater length below.

The Fuzzy ART neural network 12 may, for example, include three layers. The three layers may include an input layer 40, a comparison layer 42, and a category layer 44. Each of the layers may have nodes 50. The skilled artisan will appreciate that nodes 50a, 50b, 50c, etc., may all be nodes 50, but are marked separately to indicate that they may not be identical. The skilled artisan will also note that, while the nodes 50 may not be identical to each other, they may be reproduced in different layers. That is, although the nodes 50 are identified as being different, the fault detection system 10 according to an embodiment of the present invention contemplates that the nodes 50 in different layers can be the same due to copying, as will be discussed in greater detail below. The skilled artisan may further note that the neural network 12 according to an embodiment of the present invention may have any number of nodes, and is not limited to a set number.

The analysis of the input data is performed using the Fuzzy ART neural network. More particularly, the analysis includes passing the input data to incrementally higher numerical cascading layers. Those skilled in the art will appreciate that each layer in the incrementally higher numerical cascading layers includes an input layer, a comparison layer and a category layer. Accordingly, as the input data is passed to incrementally higher numerical cascading layers of the Fuzzy ART network, the input data is received at the input layer 40 of each of the cascading layers. Similarly, as the input data is passed and analyzed at each incrementally higher cascading layer, the input data is compared to the known data (found in the category layer 44 of each of the cascading layers) at the comparison layer 42 of each of the cascading layers. The input data is passed to the incrementally higher numerical cascading layers until either a fault or a condition indicative of a potential fault are found. Upon finding either a fault or a condition indicative of a potential fault a priority may be assigned thereto. Those skilled in the art will appreciate that the fault detection system 10 according to embodiments of the present invention contemplates that both a fault and a condition indicative of a potential fault may be detected simultaneously, and that the system is not limited to detecting either the fault or the condition indicative of the potential fault.

Also after finding the fault or condition indicative of the potential fault, the fault detection system 10 according to the present invention makes a determination as to the fault type. Determining the fault type is discussed in greater detail below, but the skilled artisan will appreciate that there exist several different ways in which the system according to the present invention may determine the type of fault that is being detected. For example, the fault type may be determined based on the type of sensor 16 that provides the input data, or may be based on the type of analysis performed using the neural network 12 according to the present invention.

A reset controller 46 may be included to reset the nodes 50 after each analysis. In other words, it is contemplated that the neural network 12 may conduct a plurality of analyses, and that the reset controller 46 may reset the nodes 50 between each analysis so that the layers may be initialized prior to conducting another analysis. That is, the input layer 40 and the comparison layer 42 may be cleared of old information. This process may prevent the neural network 12 from recognizing an anomalous pattern as a known pattern, which may cause further damage, i.e., the neural network may not recognize a particular sensed condition as a fault and, as such, may not provide a warning 36 using the user interface 18, thereby resulting in possible damage of the SHW system 8. An input pattern 38 may be received by the input layer 40 of the neural network 12. The input pattern 38 is preferably provided by the sensed data that is sensed by the sensors 16 throughout the SHW system 8. More specifically, the sensors 16 (or at least one of the sensors throughout the SHW system 8 as understood by the skilled artisan) may sense a condition and transmit that sensed condition in the form of an electronic signal which may be the input pattern, or which may, alternately, contain the input pattern. Those skilled in the art will appreciate, however, that the input pattern 38 contains information relating to the sensed condition.

The information of the input pattern 38 may include a vector or matrix, and may contain a point of data or a series of points of data. Further, the information of the input pattern 38 may be copied to the comparison layer 42, where it may be held in a short term memory (STM) 49 that may be associated with the comparison layer. A skilled artisan may appreciate that the STM 49 may be comparable to the RAM of a computer. That is, the STM 49 is volatile and may be easily changed. The neural network 12 may also have a long term memory (LTM) 48 that may be associated with the category layer 44. The category layer 44 may include a memory or database that contains information relating to the known patterns, as may be understood by those skilled in the art, after having the benefit of reading this disclosure. The LTM 48 may contain known patterns, which may be stored in vector or matrix format within the LTM, and may contain a point of data or a series of points of data. These may also be copied into the comparison layer 42 for calculations regarding comparisons. A skilled artisan may appreciate that the LTM 48 is comparable to non-volatile memory within a computer. That is, information may be written to the LTM 48, but changes associated with writing to the LTM 48 may be considerably less frequent and more permanent than in the STM 49. The skilled artisan will appreciate the comparison of the STM 49 and LTM 48 to the RAM and ROM of a computer and, having the benefit of this disclosure, may readily understand the advantage of using a computer or computerized device with, or as, the neural network 12, as discussed in greater detail above.

Once the input pattern 38 has been read by, or copied to, the STM 49, the comparison layer 42 may compare the data of the input pattern with the data of known patterns in the category layer 44. The category layer 44 may perform a calculation, or a series of calculations, to identify the node 50 in the LTM 48 that may have the most similar known pattern to the input pattern 38. The skilled artisan will recognize that the nodes 50 may contain weighting data in associated adaptive weights that may be used to perform the calculation or series of calculations. A skilled artisan will also recognize that the adaptive weights may, therefore, increase the probability that a certain node 50 will be chosen, while decreasing the probability that other nodes will be chosen.

Once a node 50 has been chosen, the known pattern contained therein may be compared directly to the input pattern 38. A similarity level of the two patterns may then be calculated, and may be compared with a vigilance level ρ (which will be discussed and detailed in formulas below). One skilled in the art may recognize that the vigilance level ρ may be a threshold percentage of similarity. If the similarity level of the known pattern and the input pattern 38 is greater than or equal to the vigilance level ρ, then a match may have been found. If the similarity level of the known pattern and the input pattern 38 is less than the vigilance level ρ, a match may not have been found.

If a match is found, the information of the input pattern 38 may be added to the node 50 having the matching known pattern. A skilled artisan may recognize that the addition of this information to the LTM 48 may allow for the neural network 12 to more readily recognize patterns with greater efficiency. Therefore, addition of new information while maintaining information already stored is considered to be an advantage of the present invention.

If a match is not found, the weights associated with the node 50 that was chosen may be set to zero to avoid choosing that node in a second calculation. In other words, if a match is not found with respect to a particular node 50, then that particular node 50 is thereafter removed from consideration in subsequent calculations. After another node 50 in the category layer 44, i.e., the LTM 48, is selected, the known pattern contained therein may be checked against the input pattern 38 for similarity, as above. This cycle may continue until a match meeting the threshold vigilance ρ may be found. If a known pattern is not found to match the input pattern 38 and meet the threshold vigilance ρ, then a new node 52 may be created. The new node may store the information of the input pattern 38. Creation of a new node 52 may be considered to be an anomaly, and existence of an anomaly may trigger a warning output 36. The warning output 36 has been discussed in greater detail above.

As indicated above, if an appropriate match between the known pattern and the input pattern is found, the LTM 48, or adaptive weights, of the Fuzzy ART neural network 12 may be updated to include the input pattern 38. This may allow the neural network 12 of the present invention to adjust its matching criteria and more readily recognize a similar input pattern. This functionality may advantageously allow the neural network 12 to process information faster and more efficiently as time progresses and use increases. If no appropriate match is found, as indicated above, a new node 52 may be created to store the input pattern 38. This may advantageously allow the neural network 12 to store new information without losing information it has stored in other nodes 50.

Referring now to flowchart 55 of FIG. 5, a method of using a Fuzzy ART neural network 12 will now be discussed in greater detail. Starting at Block 56, input data may be received by the input layer as an input pattern at Block 58. The comparison layer may compare the input pattern to nodes in the category layer at Block 60. If a match is found at Block 62, then the LTM 48 or adaptive weights associated with the matching node may be modified to store the information of the input pattern (Block 64). The process may then end at Block 70. If a match is not found at Block 62, then a new node may be created at Block 66, and the input pattern may be stored in a new node at Block 68. The process may then terminate at Block 70.

A preferred embodiment of the present invention may be to have a multi-layer hierarchical ART neural network 12. More specifically, the neural network 12 may comprise cascading layers of Fuzzy ART networks, to thereby define a Fuzzy ART neural network. Those skilled in the art will appreciate that a Fuzzy ART neural network does not necessarily need to have cascading layers (although cascading layers of the Fuzzy ART neural network are advantageous when used in connection with the present invention because of the ease of detecting various severity levels of faults), and that the embodiments of the present invention contemplate use of any neural network to readily detect faults and/or potential faults in a SHW system 8.

Each of the cascading layers of Fuzzy ART networks may be calibrated to have a vigilance level substantially proportional to its numerical layer value. The vigilance level is defined by a threshold similarity between patterns of the input data and patterns known to the neural network. As will be discussed in greater detail below, a similarity level may be determined comparing the similarity between the patterns of the input data (which is received at the input layer 40) and the known patterns (stored at the category layer 44). This comparison takes place at the comparison layer 42 of the neural network 12. This comparison is used to determine the similarity between the input data and the known data which may be presented as a percentage. The percentage may then be compared to the vigilance level to determine whether or not the percentage meets a threshold limit. As will be discussed in greater detail below with respect to the flowcharts, if it is determined that the comparison between the percentage and the vigilance level is within the threshold limit, then, at the particular level where the analysis is taking place, no fault or potential fault is indicated. Additional details as to the calculations and analyses used to determine whether or not a fault or potential fault exists are discussed in greater detail below.

The vigilance levels ρ may be substantially proportional to the respective numerical value of each layer so that, for example, the lowest vigilance level is preferably at the lowest of the cascading layers of the Fuzzy ART network, and the highest vigilance level is at the highest layer of the Fuzzy ART network. Those skilled in the art will appreciate that this order may be reversed while still accomplishing the goals, features and objectives according to the present invention. More particularly, it is contemplated that the highest vigilance level may be at the lowest layer of the Fuzzy ART network, while the lowest vigilance level may be at the highest layer of the Fuzzy ART network.

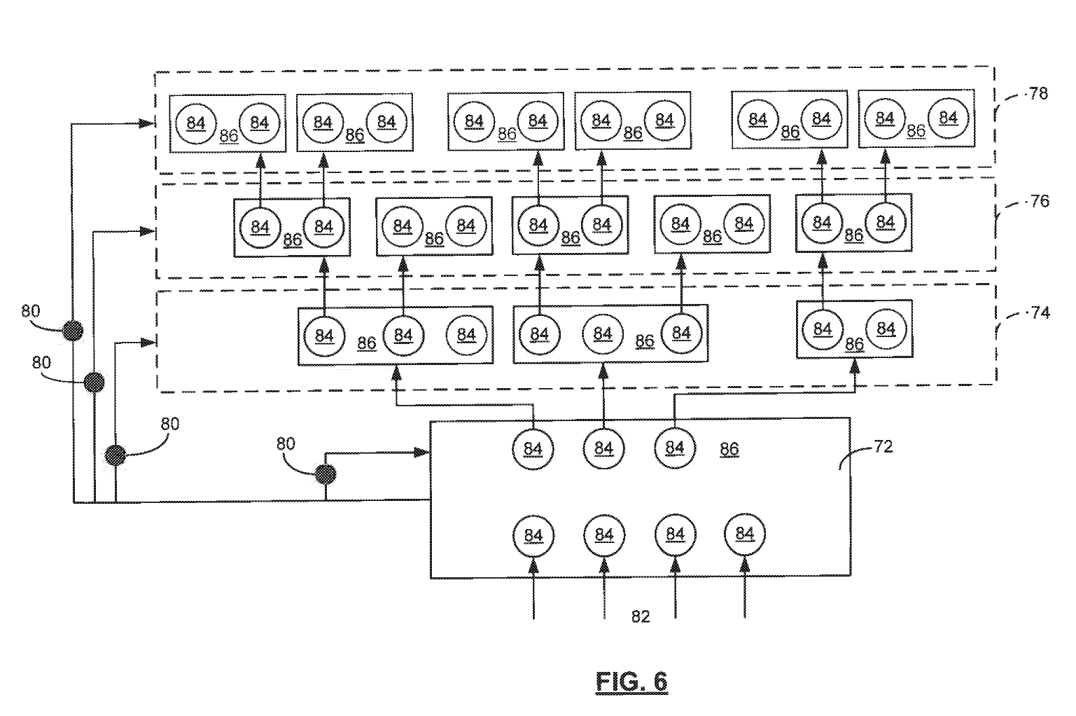

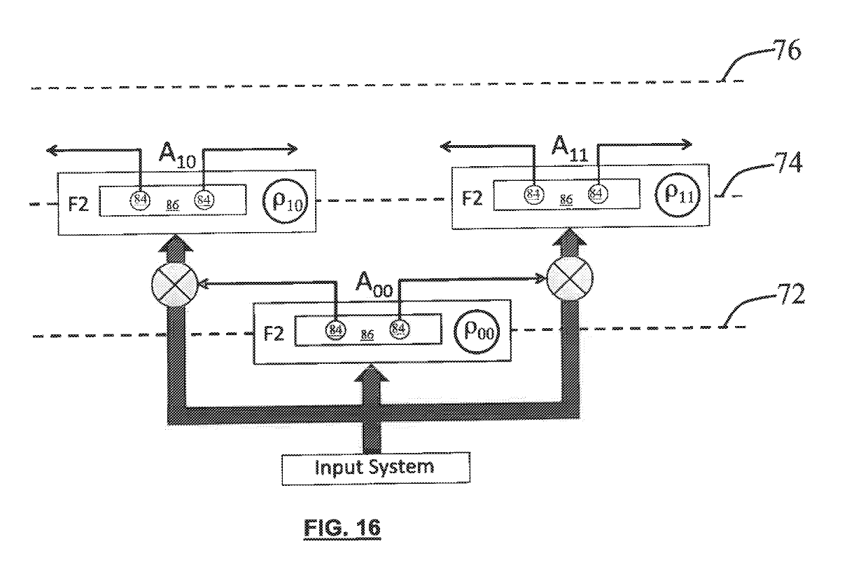

Referring now to FIG. 6, and additionally to FIG. 16, the architecture of such a neural network 12 will now be discussed in detail. The neural network 12 of FIG. 6 is portrayed as having four layers, and the neural network 12 of FIG. 16 is portrayed as having three layers, but the skilled artisan will note that any number of layers of Fuzzy ART neural networks 12 may be used to accomplish the goals, features, and objectives of the present invention. The preferred range of numbers of cascading layers of Fuzzy ART neural networks 12 is two to four cascading layers of Fuzzy ART neural networks 12. The neural network 12 of FIG. 6 has a first hierarchical layer 72, a second hierarchical layer 74, a third hierarchical layer 76, and a fourth hierarchical layer 78. Each hierarchical layer may have categories 86, which may contain one or more nodes 84. The neural network 12 may also contain reset controllers 80, which may reset the hierarchical layers after analysis. The function of reset controllers has been discussed above, and requires no further discussion herein. An input pattern 82 may be received in the first hierarchical layer 72, where a matching pattern may be searched for in a category 86 or node 84. If a match is not found, a new node 84 or category 86 may be made in the first hierarchical layer 72 to store the input pattern. If a match is found, the information of the input pattern 82 may be stored in the node 84 having the matching input pattern, and the input pattern 82 may be passed to a relevant node 84 or category 86 of the second hierarchical layer 74, where another match may be searched for.

If a match is not found in the second hierarchical layer 74, a new node 84 or category 86 may be made in the second hierarchical layer. If a match is found, the information of the input pattern 82 may be stored in the node 84 having the matching input pattern, and the input pattern 82 may be passed to a relevant node 84 or category 86 of the third hierarchical layer 76, where another match may be searched for. If a match is not found, a new node 84 or category 86 may be made in the third hierarchical layer 74. If a match is found, the information of the input pattern 82 may be stored in the node 84 having the matching input pattern, and the input pattern 82 may be passed to a relevant node 84 or category 86 of the fourth hierarchical layer 76, where another match may be searched for. If a match is not found, a new node 84 or category 86 may be made in the fourth hierarchical layer 76. If a match is found, the information of the input pattern 82 may be stored in the node 84 having the matching input pattern. It should be noted that a matching input pattern may indicate no fault, while creation of a new node or category may be indicative of a fault or a condition indicative of a potential fault. The architecture of cascading layers of Fuzzy ART neural networks 12 will be discussed in greater detail below, with reference to FIG. 16.

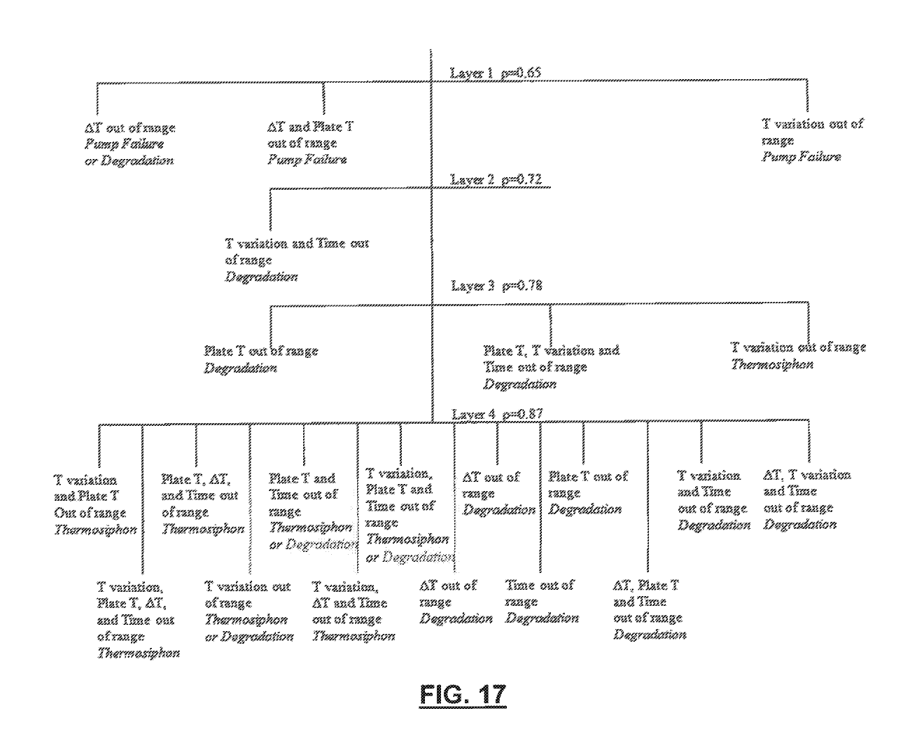

Referring to FIG. 6 and additionally to FIG. 17, an exemplary view of the branching of patterns and nodes is provided for such a four-layer hierarchical system. The nodes 50 are shown for vigilance levels ρ₂,=0.65, ρ₂,=0.72, ρ₃,=0.78, and ρ₄,=0.87. The number of nodes 50 per hierarchical layer may tend to increase with an increased vigilance level, depending on the data sets. The data sets shown in FIG. 17 are generalized for T=temperature, with three possible faults, which will be discussed at greater length below.

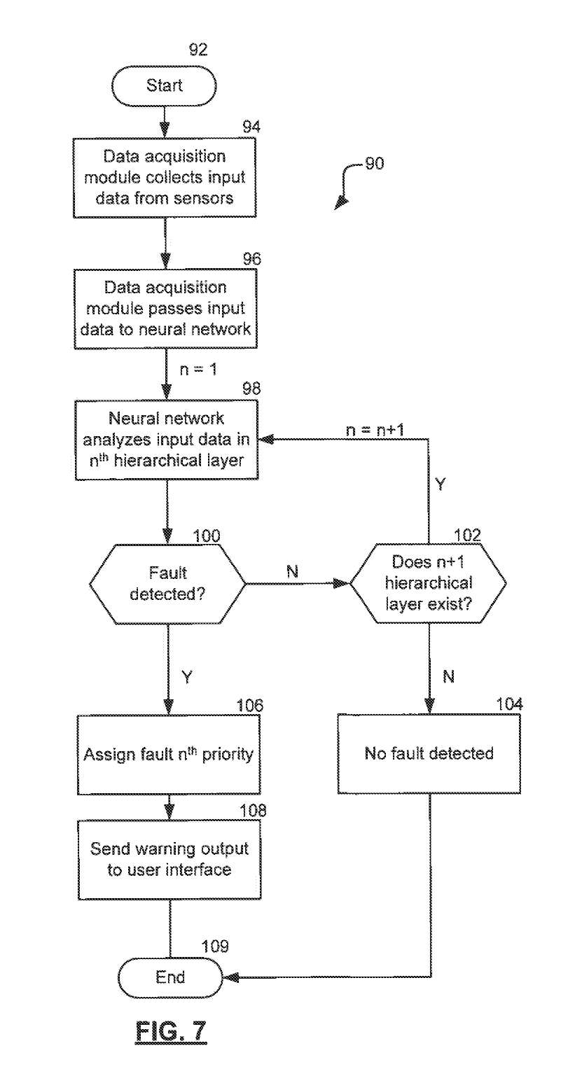

Referring now to flowchart 90 of FIG. 7, a method aspect of the present invention will now be discussed. Starting at Block 92, the data acquisition module 14 may collect input data from sensors 16 at Block 94. The data acquisition module 14 may transmit the input data to the neural network 12 at Block 96, and n may be set equal to one. At Block 98, the neural network 12 may analyze input data in the n^{th} hierarchical layer. If a fault or a condition indicative of a potential fault is detected at Block 100, the fault or condition indicative of a potential fault may be assigned n^{th} priority at Block 106, and a notification may be sent to the user interface 18 at Block 108. The method may terminate at Block 109. Conversely, if a fault or condition indicative of a potential fault is not detected at Block 100, the neural network 12 may check to see if the n+1 hierarchical layer exists at Block 102. If the n+1 hierarchical layer exists, n may be set equal to n+1 and we may return to Block 98, where the neural network 12 may analyze the input data in the n^{th} hierarchical layer. If, however, the n+1 hierarchical layer does not exist at Block 102, no fault may be detected at Block 104, and the method may end at Block 109.

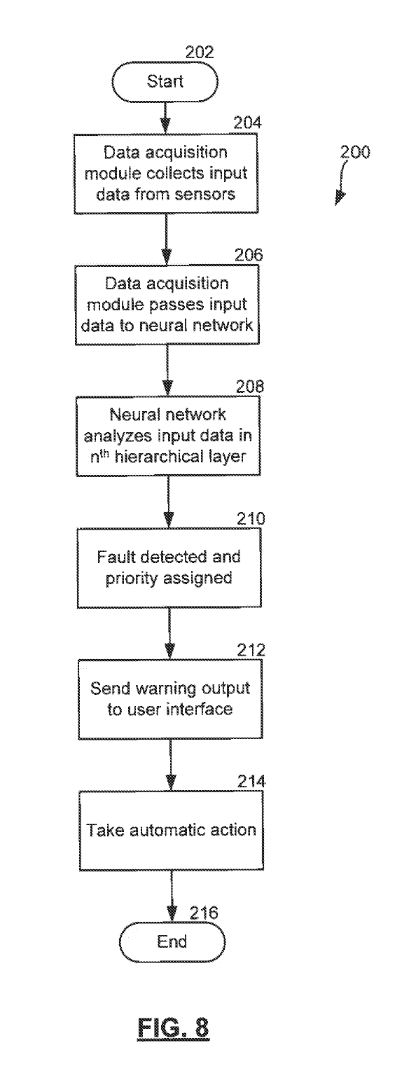

Several different embodiments of a method aspect of the present invention may come to mind, as may be recognized by one skilled in the art. Referring now to flowchart 202 of FIG. 8, one such embodiment will now be discussed. Beginning at Block 202, the data acquisition module 14 may collect input data from the sensors at Block 204. The data acquisition module 14 may pass the input data to the neural network 12 at Block 206, and the neural network 12 may analyze the input data in the nth hierarchical layer at Block 208. A fault or a condition indicative of a potential fault may be detected and priority may be assigned to the fault or condition indicative of a potential fault at Block 210. A warning output may be sent to the user interface at Block 212. The fault detection system of the present invention may take an automatic action in Block 214, ending the process at Block 216. The automatic action may be shutting down the SHW system, running the pump for an interval, or any other corrective action that may be recognized by a skilled artisan as useful in mitigating any damage the fault or condition indicative of a potential fault may cause.

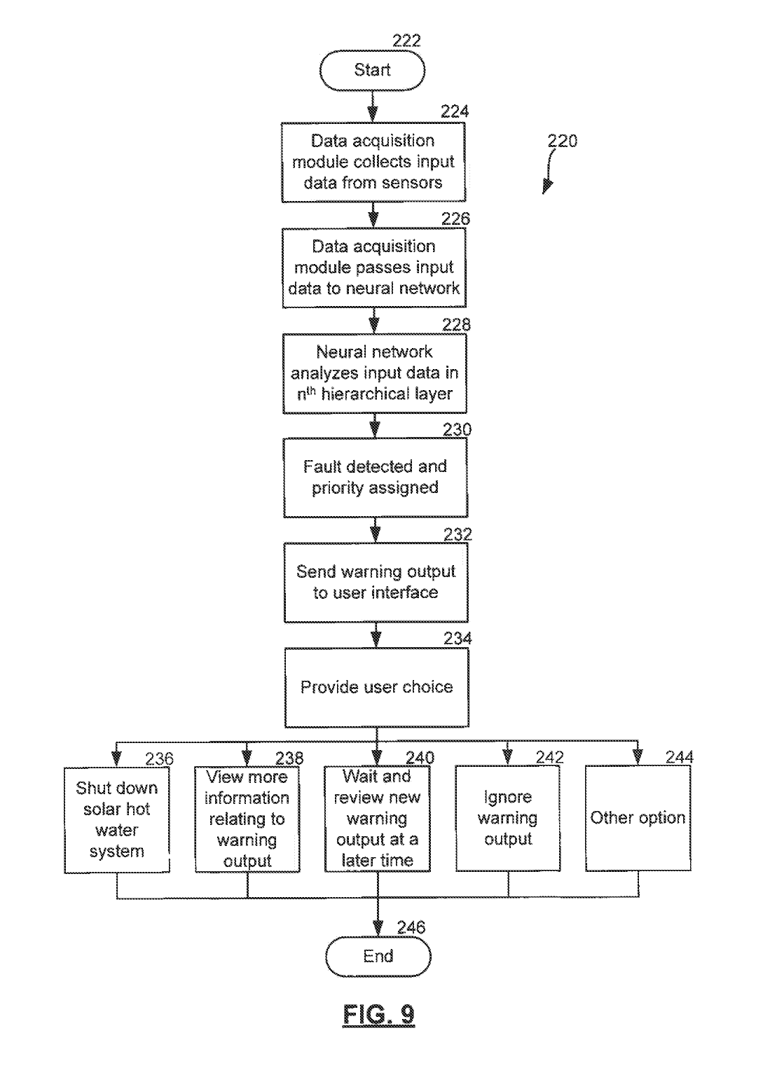

Referring now to flowchart 220 of FIG. 9, another embodiment of a method aspect of the present invention will now be discussed. Starting at Block 222, the data acquisition module 14 may collect input data from the sensors at Block 224. The data acquisition module 14 may pass the input data to the neural network 12 at Block 226, and the neural network 12 may analyze the input data in the n^{th} hierarchical layer at Block 228. A fault or condition indicative of a potential fault may be detected and a priority may be assigned at Block 230. A warning output may be sent to the user interface at Block 232, and the user may be provided with a choice at Block 234. The user may choose to shut down the SHW system (Block 236), view more information relating to the warning output (Block 238), wait and review a new warning output at a later time (Block 240), ignore the warning output (Block 242), or choose another option (Block 244). The skilled artisan will recognize that the other option of Block 244 may be any action or option recognized in the art to be useful for mitigating damage that may be caused by a fault or condition indicative of a potential fault in a SHW system 8. These potential actions have been discussed above and require no further discussion herein. The operation may terminate at Block 246.

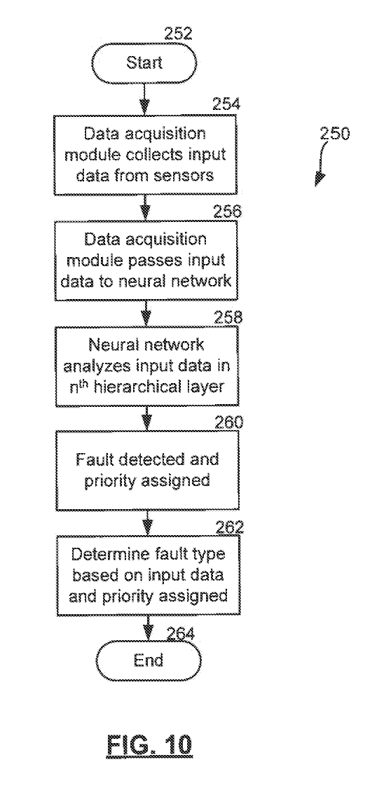

Referring now to flowchart 250 of FIG. 10, another embodiment of a method aspect of the present invention will now be described. Starting at Block 252, the data acquisition module 14 may collect input data from the sensors at Block 254. The data acquisition module 14 may pass the input data to the neural network 12 at Block 256, and the neural network 12 may analyze the input data in the n^{th} hierarchical layer at Block 258. A fault or condition indicative of a potential fault may be detected and a priority may be assigned at Block 260. The neural network 12 of the present invention may determine a fault type based on the input data and the priority assigned (Block 262), ending the process at Block 264. A skilled artisan will recognize that fault types may include, but are not limited to, a collector fault, a pipe fault, a pump fault, a thermosiphon fault, a scaling fault, a shading fault, or an unknown fault. Many other types of faults may be presented based on the different types of sensors that are included in the SHW system 8, as well as the different types of analyses that are performed by the neural network 12. A collector fault may, for example, indicate a fault or potential fault with a solar collector of the SHW system 8. A pipe fault may indicate a fault or potential fault in a pipe of the solar hot water system. A pump fault may indicate a fault or potential fault with a pump of the solar hot water system. A thermosiphon fault may indicate a fault or potential fault with a thermosiphon of the solar hot water system. A scaling fault may indicate that scales may have built up on a portion of the solar hot water system. Those skilled in the art will appreciate that the scaling fault can be provided if there exists a sensed condition that any interior portion of a pipe in the SHW system 8 is obstructed in any way. Therefore, although the fault is titled a scaling fault, such a fault may be used to detect and indicate a fault associated with any type of obstruction, or partial obstruction resulting from other buildups or clogs that are not to be limited to scaling. A shading fault may indicate that a portion of the solar hot water system may be positioned in shade. More particularly, since it is highly unlikely that the SHW system 8 was originally constructed in a shaded environment, such a fault may indicate that some condition has arisen that places the solar collectors of the SHW system 8 in shade, or that the solar collectors are, in some other manner, not exposed to sunlight. An unknown fault may indicate another type of fault or potential fault. This is meant to capture any other type of fault that may not be specifically provided for by the faults indicated above. Those skilled in the art, after having had the benefit of this disclosure, will appreciate that many other types of faults are contemplated by the present invention, and that the above described faults are provided for exemplary purposes and not meant to be limiting in any way.

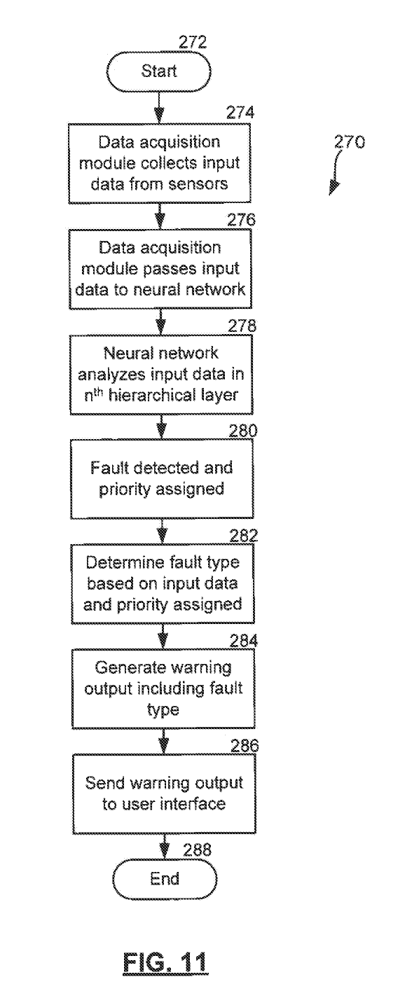

Referring now to flowchart 270 of FIG. 11, another embodiment of a method aspect of the present invention will now be described. Starting at Block 272, the data acquisition module 14 may collect input data from the sensors 16 at Block 274. The data acquisition module 14 may pass the input data to the neural network 12 at Block 276, and the neural network 12 may analyze the input data in the n^{th} hierarchical layer at Block 278. A fault or condition indicative of a potential fault may be detected and a priority may be assigned at Block 280. The neural network 12 of the present invention may determine a fault type based on the input data and the priority assigned (Block 282). Fault types have been discussed in greater detail above, and require no further discussion herein. After a fault type is determined, a warning output including the fault type may be generated at Block 284, and the warning output may be sent to the user interface Block 286. The process may end at Block 288.

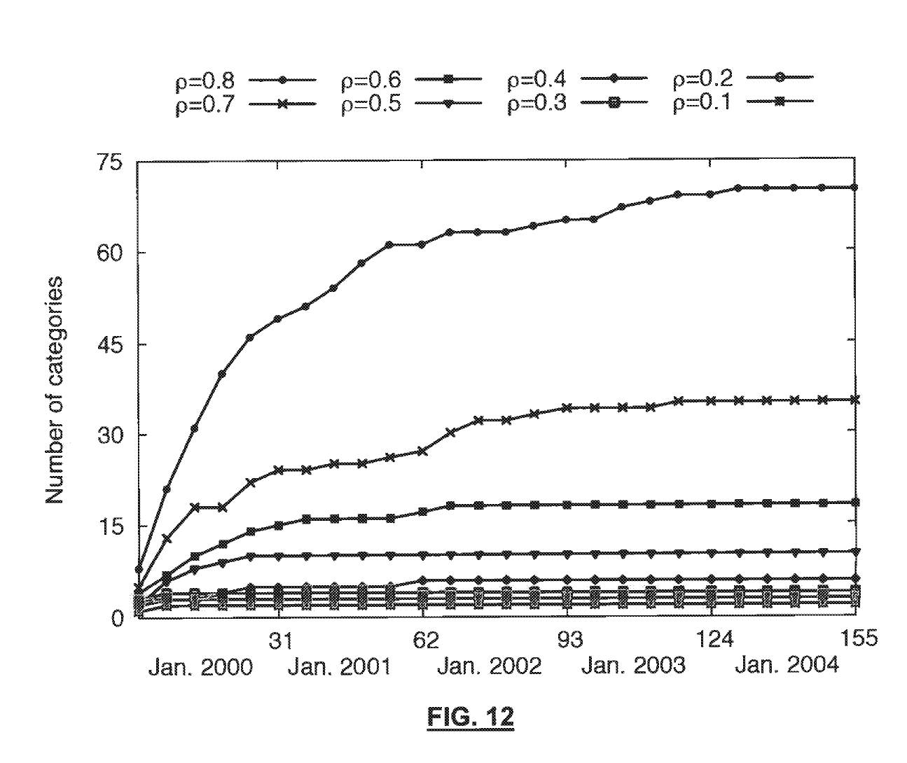

Referring now to the graph of FIG. 12, the learning process of the neural network 12 of the present invention will now be discussed. The graph depicts the number of categories that the neural network 12 may contain during learning while calibrated to vigilance level ρ at various levels. As discussed above, the vigilance level ρ may be defined as a threshold level of similarity between a known pattern and an input pattern. As the neural network 12 learns, it may create new categories and nodes to store the information of patterns that do not sufficiently match its known pattern data. Eventually, the number of categories and nodes may level out and remain at a definite number of categories and nodes known for normal operation. The skilled artisan will note that the number of categories in the graph is substantially proportional to the vigilance level ρ.

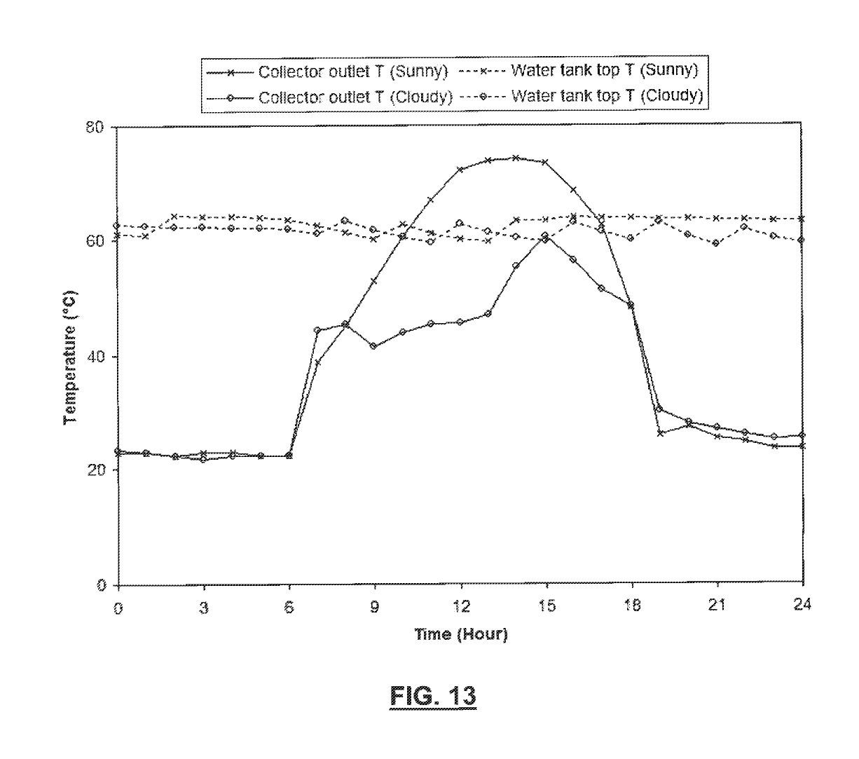

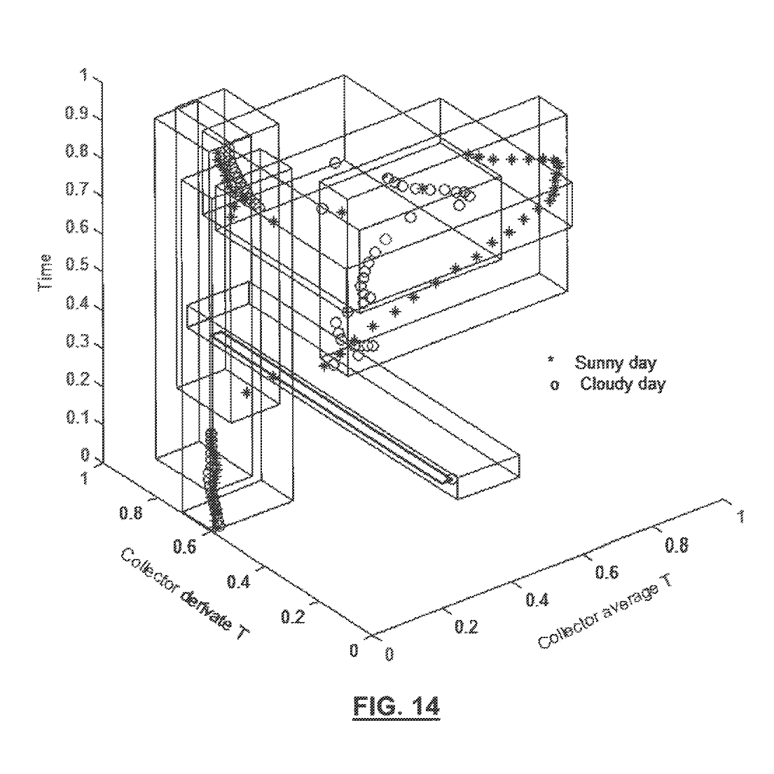

Referring now to FIGS. 13 and 14, the learning process of the neural network 12 of the present invention will now be discussed. The graph of FIG. 13 depicts various sensed conditions sensed by the sensors 16 of the data acquisition module 14 on cloudy and sunny days. Referring now to FIG. 14, the data of FIG. 13 has been analyzed by the neural network 12 of the present invention, and is presented in a three-dimensional graph. The sunny and cloudy days are plotted according to the analysis, and are placed in three-dimensional spatial categories. Should the neural network 12 receive data that cannot be categorized in the existing three-dimensional spatial categories, the neural network 12 may attempt to create a new three-dimensional spatial category to store the data. Although the human mind may most easily visualize only three dimensions, a skilled artisan will recognize that categories need not be three-dimensional, but may be any size, including, but not limited to, two-dimensional, one-dimensional, four-dimensional, five-dimensional, or larger, to suit the needs of the given neural network 12.

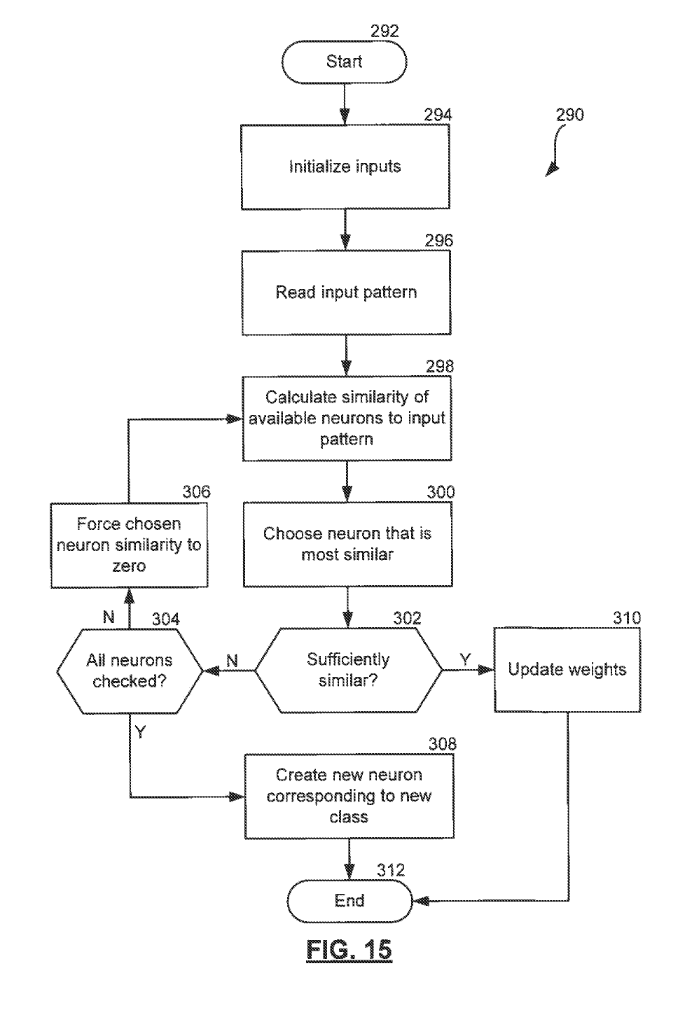

Referring now to flowchart 290 in FIG. 15, the analytical processes of the neural network 12 of the present invention will now be discussed in greater detail. The neural network 12 may have an input layer 40 (layer F0), a comparison layer 42 (layer F1), and a recognition layer 44 (layer F2). To avoid confusion, it may be noted that the skilled artisan may recognize that nodes and neurons may be considered, by some, to be one and the same. The comparison layer 42 may have n neurons (uᵢ, i=1, 2, . . . , n). There may be in neurons (uⱼ, j=1, 2, . . . m) in the recognition layer 44, and each neuron in the comparison layer 42 may be connected to each neuron in the recognition layer 44 through a bottom-up weight matrix B=(bⱼᵢ)_{m×n}, where bⱼᵢ may represent the weight given to neuron uⱼ in the recognition layer from neuron uᵢ in the comparison layer. Conversely, the analog output of each neuron in the recognition layer is connected to all neurons in the comparison layer through a top-down weight matrix T=(tᵢⱼ)_{m×n}, where tᵢⱼ may represent the weight given to neuron uᵢ in the comparison layer 42 from neuron uⱼ in the recognition layer 44. Starting at Block 292, the inputs may be initialized at Block 294. That is, m=0,

$${b}_{ji} ( 0 ) = \frac{1}{n + 1} ,$$

and tᵢⱼ(0)=1. Then, at Block 296 the input pattern may be read. The input pattern may be represented as x=(x₁, . . . , xₙ), where xᵢ ∈ {0, 1}.

At Block 298 similarity μᵢ may be calculated. The calculation for μⱼ is given as μⱼ=x^{T}Bⱼ=Σᵢ₌₁ⁿ bⱼᵢuᵢ. This is known as the choice function. At Block 300, the neuron that is most similar may be chosen, using the function μⱼ*=max_{1≦j≦m}{μⱼ}. The neuron uⱼ may activate, and may inhibit all other neurons in the recognition layer 44 from activating. In the case of multiple maximum values, the neuron j with the smallest index may be chosen, resulting in a recognition layer output given by R={r₁, . . . , rⱼ*, . . . rₘ}^{T}=(0, . . . , 1, . . . , 0)^{T}. At Block 302, the neural network 12 may check to see that the chosen neuron and the input pattern are sufficiently similar. This may be done by initiating the feedback process. Input Tⱼ* may be found by setting tᵢⱼ to tᵢⱼ*=Σⱼ₌₁^{m} tᵢⱼRⱼ. This may allow the appropriateness of the neuron to be checked against vigilance parameter ρ, using the equation

$${γ}_{{j}^{*}} = \frac{\vert x ⋂ {T}_{{j}^{*}} \vert}{\vert x \vert} > ρ .$$

In this equation, |x| may be the 1-normal |x|=ρᵢ₌₁^{N} xᵢ. ∩ may be the intersection operation, and ρ ∈ (0, 1]. If this equation is not satisfied, the neural network may check to see if all neurons have been compared to the input at Block 304. If there are more neurons to compare, yⱼ* may be forced to zero, inhibiting the same neuron from being chosen in another round at Block 306, and the process may return to Block 298, where similarity may be once again calculated. If all the neurons have been checked, a new recognition layer neuron may be created at Block 308, where m=m+1, tᵢₘ=1, and

$${b}_{mi} = \frac{1}{n + 1} ,$$

ending the process at Block 312. If, at Block 302, the patterns are found to be sufficiently similar, the weights may be updated at Block 310, using the equations tᵢⱼ*(p+1)=tᵢⱼ*(p)xᵢ,

$${b}_{{j}^{*} i} ( p + 1 ) = \frac{{t}_{{ij}^{*}} ( p ) {x}_{i}}{α + {\sum }_{i} {t}_{{ij}^{*}} ( p ) {x}_{i}} ,$$

tᵢⱼ(p 30 1)=tᵢⱼ(p), and bⱼᵢ(p+1)=bᵢⱼ(p), where j≠j*. In this case, p is the index of the current time step, and a is the choice parameter. This calculation may end the process at Block 312.

The skilled artisan may recognize that the process detailed above may be for use in a binary ART system. The skilled artisan will also recognize that a few minor adjustments to the existing process may make the existing process suitable for use with analog inputs as a Fuzzy ART system. This may be done by first adjusting the input patterns to be analog or binary valued, that is, xᵢ ∈ [0, 1] or xᵢ ∈ {0, 1}, respectively. The second adjustment that may be made is setting the top-down weight vectors and bottom-up weight vectors equal to each other, that is, B=T^{T}=W. Finally, the intersection operation n may be replaced with the Fuzzy MIN operator [symbol] . This means that (x [symbol] y)ᵢ=min(xᵢ, yᵢ). All operations, equations, and processes otherwise remain the same, as will be readily recognized by one skill in the art.

By varying the vigilance parameter, it is possible to set the classification strategy of an ART (binary or fuzzy) network from very coarse to very fine-grained. In other words, the classification strategy may have a very low or very high vigilance level. An excessively fine-grained classification could result in many false alarms, while an excessively coarse classification could miss important signals of a developing failure. To overcome this dilemma, it is possible to utilize a series of ART networks, which are connected in a hierarchical structure. In these, an initial coarse-grained classification (i.e. with low vigilance parameter) is followed by subsequent finer-grained ones with successively higher vigilance parameters.

Consider the hierarchical ART (HART) network illustrated in FIG. 16, previously mentioned above, and an input pattern under examination traversing it from bottom to top. At the lowest level, the pattern is either classified into an existing class or node 84, or a new class or node 84 is created if the pattern is novel. At this level, the vigilance parameter ρ₀₀ is low, and the number of categories 86 is small. Novelty only arises if the pattern is substantially different from any of the existing ones, such as would be the case for the catastrophic failure of an important system component. Accordingly, creation of the new class or node 84 would generally be associated with a ‘high-severity’ alarm or warning output 36. Following classification or novelty detection, the input pattern is routed to an ART network at the next level up, that is uniquely associated with the class or node 84 just chosen. All ART networks at this new level are characterized by a vigilance parameter ρ₁ᵢ>ρ₀₀. Note that, in principle, each ρ₁ᵢ could take different values, although in the present case a single vigilance parameter (ρₖ) for each level k is adopted. The input pattern is again classified, and either matched with an existing class or node 84, or, if the pattern is novel, a new class or node 84 is created. Novelty at this level may result from a less severe failure, from progressive component degradation, or from hitherto unseen, but normal operating conditions, a fairly common occurrence in renewable energy systems. An alarm or warning output 36 would still be issued alongside the novelty detection, but with reduced severity. The input pattern is then passed on to the ART network at the next level up which is associated with the chosen class or node 84, and so on until the penultimate level is reached.

For the specific case of a cascade of Fuzzy ART module the specific steps for hierarchical classification of an input pattern are as follows:

Step 1: set the number of layers, L+1, set the vigilance parameters, ρ₀<ρ₁ < . . . <ρ_{L}, and set the initial weights, w_{k:ij}=1.

Step 2: present an analog pattern x={x₁, . . . , xₙ}, where xᵢ ∈ [0, 1].

Step 3: input pattern for layer k is x^{k}, (0≦k≦L); input pattern for layer k+1, (k≦L) is x^{k+1}=x^{k}. In comparison layer F1^{k}, if the class j of F2^{k} is active and Fuzzy ART module k−1 is in resonance, y1^{k}=x^{k} [symbol] w_{k:j}; else y1^{k}=x^{k}. In layer F2^{k}, if the class j of F2^{k} is active and Fuzzy ART module k−1 is in resonance, y2ⱼ^{k}=1 else y2ⱼ^{k}=0, If the module k−1 is in resonance, μⱼ^{k} is calculated by

$${μ}_{j}^{k} = \frac{\vert {x}^{k} {w}_{k : j} \vert}{α + \vert {w}_{k : j} \vert} ,$$

where α is the choice parameter. Note that α should be set to a small positive value for single pass convergence with Fuzzy ART. The vigilance criterion for layer k is

$$\frac{\vert {w}_{k : j} {x}^{k} \vert}{{x}^{k}} \geq {ρ}_{k} ,$$

where the index J corresponds to the maximum value of μⱼ^{k}.

Step 4: update the weights. If the active class in layer F2^{k} is J and inequality for the vigilance criterion is true, then update the weights: w_{k:J}^{new}=β(x^{k} [symbol] w_{k:J}^{old})+(1−β)w_{k:J}^{old}.

Step 5: return to step 2 until no new class is created and the weights are stable.

Many additional modifications and embodiments of the invention will come to the mind of one skilled in the art having the benefit of the teachings presented in the foregoing descriptions and the associated drawings to accomplish the goals, features, and objectives of the present invention. Therefore, it is understood that the invention is not to be limited to the specific embodiments disclosed, and that modifications and embodiments are intended to be included within the scope of the appended claims.

That which is claimed is:

1. A fault detection system for use with a solar hot water system, the fault detection system comprising:
a data acquisition module to collect input data relating to the solar hot water system, the data acquisition module comprising a plurality of sensors in communication with portions of the solar hot water system, the input data relating to a sensed condition sensed by at least one of the plurality of sensors;
a neural network in communication with the data acquisition module to receive the input data, the neural network being a multi-layer hierarchical adaptive resonance theory (ART) neural network; and
a user interface in communication with at least one of the neural network and the data acquisition module;
wherein the data acquisition module transmits the input data to the neural network;
wherein the neural network performs an analysis on the input data to determine existence of at least one of a fault and a condition indicative of a potential fault;
wherein at least one of the fault and the condition indicative of the potential fault are prioritized according to the analysis performed by the neural network;
wherein a warning output relating to at least one of the fault and the condition indicative of the potential fault is generated responsive to the analysis; and
wherein the warning output is displayed on the user interface.

2. A system according to claim 1 wherein the plurality of sensors comprises at least one of a collector outlet temperature sensor, a storage water tank top temperature sensor, a controller signal sensor, a collector inlet temperature sensor, a collector fin temperature sensor, a storage water tank bottom temperature sensor, a flow rate sensor, an ambient temperature sensor, a global radiation sensor, a beam radiation sensor, an incidence angle sensor, a wind speed sensor, a relative humidity sensor, and a time of day sensor.

3. A system according to claim 1 wherein the fault and the condition indicative of the potential fault are related to at least one of a collector fault indicating a fault or potential fault with a solar collector of the solar hot water system, a pipe fault indicating a fault or potential fault in a pipe of the solar hot water system, a pump fault indicating a fault or potential fault with a pump of the solar hot water system, a thermosiphon fault indicating a fault or potential fault with a thermosiphon of the solar hot water system, a scaling fault indicating that scales have built up on a portion of the solar hot water system, a shading fault indicating that a portion of the solar hot water system is in shade, and an unknown fault indicating another type of fault or potential fault.

4. A system according to claim 1 wherein the neural network comprises a plurality of cascading layers of Fuzzy ART networks.

5. A system according to claim 4 wherein each of the cascading layers of Fuzzy ART networks is calibrated to have a vigilance level substantially proportional to its numerical layer value, wherein the vigilance level is defined by a threshold similarity between patterns of the input data and patterns known to the neural network.

6. A system according to claim 5 wherein the analysis comprises:
passing the input data to incrementally higher numerical cascading layers of Fuzzy ART networks in the neural network until at least one of the fault and the condition indicative of the potential fault are found; and
assigning the fault and the condition indicative of the potential fault a priority based on the numerical cascading layers in which the fault and the condition indicative of the potential fault are found.

7. A system according to claim 6 wherein the neural network identifies the fault and the condition indicative of the potential fault as a fault type based on the input data received by the neural network and based on the priority assigned to the fault and the condition indicative of the potential fault during the analysis of the input data.

8. A system according to claim 1 wherein the solar hot water system further comprises a controller that controls operation of the solar hot water system, and wherein the neural network is in communication with the controller.

9. A system according to claim 8 wherein the controller receives an output control signal relating to operation of the solar hot water system from the neural network; wherein the controller transmits a control signal to portions of the solar hot water system; and wherein the control signal is generated responsive to the analysis and the warning output.

10. A system according to claim 1 wherein the warning output comprises a prompt that allows a user to make a choice using the user interface, the choice including at least one of:
shutting down the solar hot water system;
viewing more information relating to the warning output;
waiting a time period and reviewing a new warning output at a later time; and
ignoring the warning output.

11. A system according to claim 10 wherein the neural network is a learning system including a knowledge base; and wherein the knowledge base of the neural network is augmented based on the choice of ignoring the warning output being selected.

12. A system according to claim 10 wherein the user is a solar hot water system monitoring service or a maintenance service.

13. A system according to claim 12 wherein the user interface is positioned at a facility associated with the solar hot water system monitoring service or the maintenance service.

14. A fault detection system for use with a solar hot water system having a controller that controls operation of the solar hot water system, the fault detection system comprising:
a data acquisition module to collect input data relating to the solar hot water system, the data acquisition module comprising a plurality of sensors in communication with portions of the solar hot water system, the input data relating to a sensed condition sensed by at least one of the plurality of sensors;
a neural network in communication with the data acquisition module to receive the input data, and in communication with the controller, the neural network being a multi-layer hierarchical adaptive resonance theory (ART) neural network; and
a user interface in communication with at least one of the neural network and the data acquisition module;
wherein the data acquisition module transmits the input data to the neural network;
wherein the neural network performs an analysis on the input data to determine existence of at least one of a fault and a condition indicative of a potential fault;
wherein at least one of the fault and the condition indicative of the potential fault are prioritized according to the analysis performed by the neural network;
wherein a warning output relating to at least one of the fault and the condition indicative of the potential fault is generated responsive to the analysis;
wherein the warning output is displayed on the user interface, and wherein the warning output comprises a prompt that allows a user to make a choice using the user interface, the choice including at least one of
shutting down the solar hot water system,
viewing more information relating to the warning output,
waiting a time period and reviewing a new warning output at a later time, and
ignoring the warning output; and
wherein the controller receives an output control signal relating to operation of the solar hot water system from the neural network;
wherein the controller transmits a control signal to the solar hot water system; and
wherein the control signal is generated responsive to the analysis and the warning output.

15. A system according to claim 14 wherein the plurality of sensors comprises at least one of a collector outlet temperature sensor, a storage water tank top temperature sensor, a controller signal sensor, a collector inlet temperature sensor, a collector fin temperature sensor, a storage water tank bottom temperature sensor, a flow rate sensor, an ambient temperature sensor, a global radiation sensor, a beam radiation sensor, an incidence angle sensor, a wind speed sensor, a relative humidity sensor, and a time of day sensor.

16. A system according to claim 14 wherein the fault is related to at least one of a collector fault indicating a fault or potential fault with a solar collector of the solar hot water system, a pipe fault indicating a fault or potential fault in a pipe of the solar hot water system, a pump fault indicating a fault or potential fault with a pump of the solar hot water system, a thermosiphon fault indicating a fault or potential fault with a thermosiphon of the solar hot water system, a scaling fault indicating that scales have built up on a portion of the solar hot water system, a shading fault indicating that a portion of the solar hot water system is in shade, and an unknown fault indicating another type of fault or potential fault.

17. A system according to claim 14 wherein the neural network comprises a plurality of cascading layers of Fuzzy ART networks.

18. A system according to claim 17 wherein each of the cascading layers of Fuzzy ART networks is calibrated to have a vigilance level substantially proportional to its numerical layer value, wherein the vigilance level is defined by a threshold similarity between patterns of the input data and patterns known to the neural network.

19. A system according to claim 18 wherein the analysis comprises:
passing the input data to incrementally higher numerical cascading layers of Fuzzy ART networks in the neural network unto at least one of the fault and the condition indicative of the potential fault are found; and
assigning the fault and the condition indicative of the potential fault a priority based on the numerical cascading layers in which the fault and the condition indicative of the potential fault are found.

20. A system according to claim 19 wherein the neural network identifies the fault and the condition indicative of the potential fault as a fault type based on the input data received by the neural network and based on the priority assigned to the fault and the condition indicative of the potential fault during the analysis of the input data.

21. A system according to claim 14 wherein the neural network is a learning system including a knowledge base; and wherein the knowledge base of the neural network is augmented based on the choice of ignoring the warning output being selected.

22. A system according to claim 14 wherein the user is a solar hot water system monitoring service or a maintenance service.

23. A system according to claim 22 wherein the user interface is positioned at a facility associated with the solar hot water system monitoring service or the maintenance service.

24. A method of using a fault detection system with a solar hot water system having a controller that controls operation of the solar hot water system, the fault detection system comprising a data acquisition module having a plurality of sensors in communication with portions of the solar hot water system to collect input data relating to a sensed condition sensed by at least one of the plurality of sensors, a neural network in communication with the data acquisition module and the pump controller, the neural network being a multi-layer hierarchical adaptive resonance theory (ART) neural network, and a user interface in communication with at least one of the neural network and the data acquisition module, the method comprising:
collecting the input data relating to the solar hot water system;
transmitting the input data from the data acquisition module to the neural network;
executing a command to perform an analysis on the input data within the neural network;
determining existence of at least one of a fault and a condition indicative of a potential fault;
prioritizing at least one of the fault and the condition indicative of the potential fault according to the analysis performed by the neural network;
generating a warning output relating to at least one of the fault and the condition indicative of the potential fault responsive to the analysis;
displaying the warning output on the user interface;
providing a prompt that allows a user to make a choice using the user interface, the choice including at least one of
shutting down the solar hot water system,
viewing more information relating to the warning output,
waiting a time period and reviewing a new warning output at a later time, and
ignoring the warning output; and
transmitting an output control signal relating to operation of the solar hot water system from the neural network to the controller, wherein the controller sends a control signal to the solar hot water system, and wherein the control signal is generated responsive to the analysis and the warning output.

25. A method according to claim 24 wherein the plurality of sensors comprises at least one of a collector outlet temperature sensor, a storage water tank top temperature sensor, a controller signal sensor, a collector inlet temperature sensor, a collector fin temperature sensor, a storage water tank bottom temperature sensor, a flow rate sensor, an ambient temperature sensor, a global radiation sensor, a beam radiation sensor, an incidence angle sensor, a wind speed sensor, a relative humidity sensor, and a time of day sensor.

26. A method according to claim 24 wherein the fault is related to at least one of a collector fault indicating a fault or potential fault with a solar collector of the solar hot water system, a pipe fault indicating a fault or potential fault in a pipe of the solar hot water system, a pump fault indicating a fault or potential fault with a pump of the solar hot water system, a thermosiphon fault indicating a fault or potential fault with a thermosiphon of the solar hot water system, a scaling fault indicating that scales have built up on a portion of the solar hot water system, a shading fault indicating that a portion of the solar hot water system is in shade, and an unknown fault indicating another type of fault or potential fault.

27. A method according to claim 24 wherein the neural network comprises a plurality of cascading layers of Fuzzy ART networks.

28. A method according to claim 27 further comprising calibrating each of the cascading layers of Fuzzy ART networks to have a vigilance level substantially proportional to its numerical layer value, wherein the vigilance level is defined by a threshold similarity between patterns of the input data and patterns known to the neural network.

29. A method according to claim 28 wherein the analysis comprises:
passing the input data to incrementally higher numerical cascading layers of Fuzzy ART networks in the neural network until at least one of the fault and the condition indicative of the potential fault are found; and
assigning the fault and the condition indicative of the potential fault a priority based on the numerical cascading layers in which the fault and the condition indicative of the potential fault are found.

30. A method according to claim 29 further comprising identifying the fault and the condition indicative of the potential fault as a fault type based on the input data received by the neural network and based on the priority assigned to the fault during the analysis of the input data.

31. A method according to claim 24 wherein the neural network is a learning system including a knowledge base; and further comprising augmenting the knowledge base of the neural network based on the choice of ignoring the warning output being selected.

32. A method according to claim 24 wherein the user is a solar hot water system monitoring service or a maintenance service.

33. A method according to claim 32 wherein the user interface is positioned at a facility associated with the solar hot water system monitoring service or the maintenance service.
